(19) United States
(12) Patent Application Publication
(10) Pub. No.: US 2004/0055809 A1
(43) Pub. Date: Mar. 25, 2004

(54) Method and device for the identification of an inclined face

(76) Inventors: Gabriel Wetzel, Korntal (DE); Klaus-Dieter Leimbach, Eschach (DE)

Correspondence Address: KENYON & KENYON, ONE BROADWAY, NEW YORK, NY, 10004, US

(21) Appl. No.: 10/416,394

(22) PCT Filed: Aug. 22, 2002
(86) PCT No.: PCT/DE02/03075

(30) Foreign Application Priority Data
Sep. 12, 2001 (DE) 101 44 880.5

(51) Int. Cl. B62D 5/04

(52) U.S. Cl. 180/444

(57) ABSTRACT

A device and a method for recognizing the crossfall of a road surface. They may be used in a vehicle equipped with measurement means for detecting at least one variable describing the operating dynamics of the vehicle and with analyzing means for recognizing the crossfall of a road surface. The vehicle has steering control means and for recognition of the crossfall of the road surface at least one steering operation performed independently of the driver is initiated by the steering control means on wheels designed to be steerable. In addition, at least one variable which influences the operating dynamics of the vehicle is detected in the measurement means during the steering operation. In addition, a crossfall of the road surface is recognized in the analyzing means at least by analyzing the variable which influences the operating dynamics of the vehicle during the at least one steering operation.

### FIELD OF THE INVENTION

The present invention is directed to a device for determining a road surface gradient variable.

### BACKGROUND INFORMATION

German Patent Application No. 197 08 508 describes a device and a method of regulating a movement variable representing the movement of a vehicle. This device includes first means for detecting at least the transverse acceleration of the vehicle. The device also includes second means, at least for determining a transverse acceleration component which depends on the crossfall transverse gradient of the road surface and/or for correction of at least the transverse acceleration of the vehicle, at least as a function of the transverse acceleration component. The second means determine a vehicle state, in which the transverse acceleration component depending on the road surface crossfall is determined, at least as a function of the slip angle at the rear axle of the vehicle.

German Patent Application No. 199 14 727 relates to a device for determining a road surface gradient variable which describes the gradient of a road surface on which a vehicle is situated. To do so, the device includes a liquid container situated in the area of the vehicle, containing a liquid, at least one pressure sensor which is situated in the area of the bottom of the liquid container and with which a pressure variable describing the liquid pressure in the liquid container is determined, and including an analyzer unit connected to the pressure sensor. The road surface gradient variable is determined in the analyzer unit as a function of the pressure variable.

In conventional steer-by-wire steering systems, the steering wheel operable by the driver of the vehicle is not mechanically connected directly to the steerable wheels. In addition, German Patent No. 40 31 316 (corresponding to U.S. Pat. No. 5,205,371) describes a superimposed steering in which the steering wheel, which is operable by the driver of the vehicle, is mechanically connected directly to the steerable wheels but steering measures may be implemented independently of the driver.

### SUMMARY

The present invention relates to a method and a device for highbank recognition. This involves detection of a road surface gradient across the direction of travel of the vehicle.

Recognition of highbanks, e.g., for further processing in vehicle operating dynamics control systems (such as the electronic stability program, ESP) is appropriate and advantageous because this additional information makes possible more precise measures on the part of the vehicle operating dynamics control system.

An example device and method of recognizing a road surface gradient across the direction of travel are described; they may be used in a vehicle equipped with

measurement means for detecting at least one variable describing the operating dynamics of the vehicle and

analyzing means for recognizing the crossfall of a road surface.

According to an example embodiment of the present invention, the vehicle must have steering control means. For recognition of the crossfall of the road surface

at least one steering operation performed independently of the driver is initiated by the steering control means on wheels designed to be steerable,

at least one variable which influences the operating dynamics of the vehicle is detected in the measurement means during the steering operation, and

a crossfall of the road surface is recognized in the analyzing means at least by analyzing the variable which influences the operating dynamics of the vehicle during the at least one steering operation.

An advantage of the example embodiment of the present invention may be that it does not operate on the principle of a liquid container having pressure sensors mounted in it. Due to this elimination of complex mechanical components, the advantages of lower weight, greater freedom from maintenance and simple integrability as an additional functionality into existing control units are yielded.

It may be advantageous if the yaw rate and/or transverse acceleration is detected in the measurement means during the at least one steering operation. Therefore, there is frequently no additional cost because a yaw rate sensor and/or a transverse acceleration sensor is present anyway in a vehicle equipped with a vehicle operating dynamics control system.

An advantageous embodiment is characterized in that the recognition of a crossfall of a road surface is based on the performance and analysis of two opposite steering operations performed independently of the driver on wheels designed to be steerable.

It also may be advantageous if the yaw rate and/or the transverse acceleration of the vehicle is determined in the measurement means during both steering operations.

An advantageous analysis option is characterized in that detection of a road surface gradient across the direction of travel is based on a comparison performed in the analyzing means, whereby the two yaw rates and/or transverse accelerations determined during the two steering operations enter into the comparison.

Another advantageous embodiment of the present invention is characterized in that

a steering operation performed independently of the driver is initiated in the steering control means on wheels designed to be steerable,

a variable which describes the operating dynamics of the vehicle is determined by the measurement means during the steering operation,

the vehicle has computing means for determining at least one variable which describes the operating dynamics of the vehicle with the help of a model,

a variable which describes the operating dynamics of the vehicle is calculated in the computing means and

for detection of a road surface having a transverse gradient in the analyzing means, the variable determined in the measurement means and the variable calculated in the computing means are used.

In this example embodiment, it may be advantageous

if the yaw rate and/or the transverse acceleration of the vehicle is determined by the measurement means during the one steering operation,

if the yaw rate and/or the transverse acceleration of the vehicle is calculated in the computing means and

if the detection of a road surface gradient across the direction of travel is based on a comparison performed in the analyzing means, whereby the comparison is based on

the yaw rate determined as well as the calculated yaw rate and/or

the transverse acceleration determined as well as the calculated transverse acceleration.

It may be advantageous here if the yaw rate is calculated in the computing means by a model using the longitudinal velocity of the vehicle and the steering angle of the front wheels as input variables and/or the transverse acceleration is calculated by a model using the longitudinal velocity of the vehicle as an input variable. Since these variables are available anyway in a modern motor vehicle, this does not require any additional complexity.

### BRIEF DESCRIPTION OF THE DRAWINGS

An exemplary embodiment of the present invention is illustrated in the following drawing and explained below.

FIG. 1 shows the influence of a highbank on the transverse acceleration signal.

FIG. 2a shows in an exemplary manner the lateral force as a function of the slip angle.

FIG. 2b shows a visual illustration of the slip angle.

FIG. 3 shows the influence of a driver steering measure on the yaw rate setpoint calculated using a single-track vehicle model.

FIG. 4a shows schematically the influence of driver steering measures with a horizontal road surface.

FIG. 4b shows schematically the influence of driver steering measures in a highbank.

FIG. 5 shows a flow chart illustrating the recognition of a highbank via two steering measures in different directions. Yaw rates are analyzed here.

FIG. 6 shows a flow chart illustrating the recognition of a highbank via just one steering measure. Yaw rates are analyzed here.

FIG. 7 shows a block diagram illustrating the basic idea of the present invention.

FIG. 8 shows a flow chart illustrating the recognition of a highbank via two steering measures in different directions. Transverse accelerations are analyzed here.

FIG. 9 shows a flow chart illustrating the recognition of a highbank via just one steering measure. Transverse accelerations are analyzed here.

### DETAILED DESCRIPTION

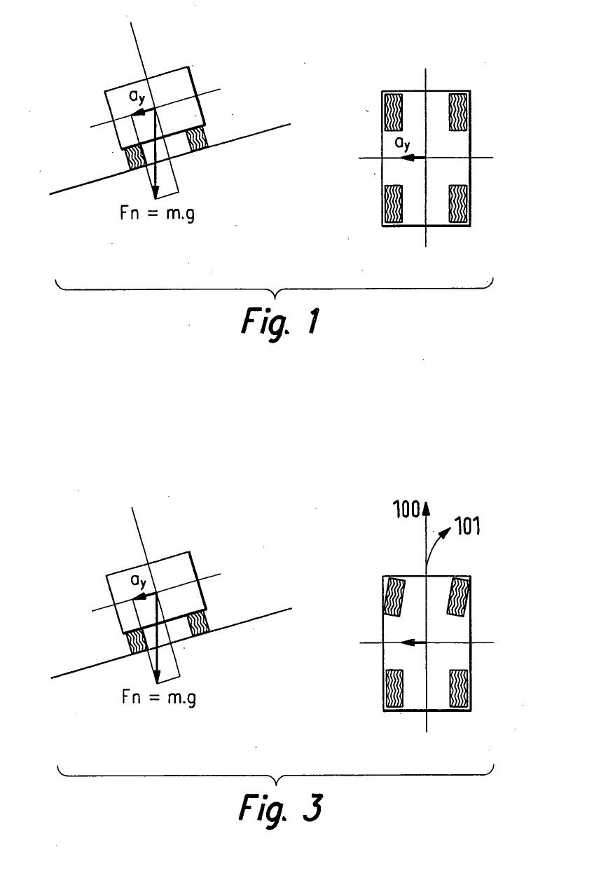

FIG. 1 shows, an the left, a vehicle on a road surface having a gradient across the direction of travel. The force due to the weight of the vehicle may be broken down into two components:

1. a normal component perpendicular to the plane of the road surface and

2. a tangential component parallel to the plane of the road surface.

This tangential component corresponds to a transverse acceleration ay.

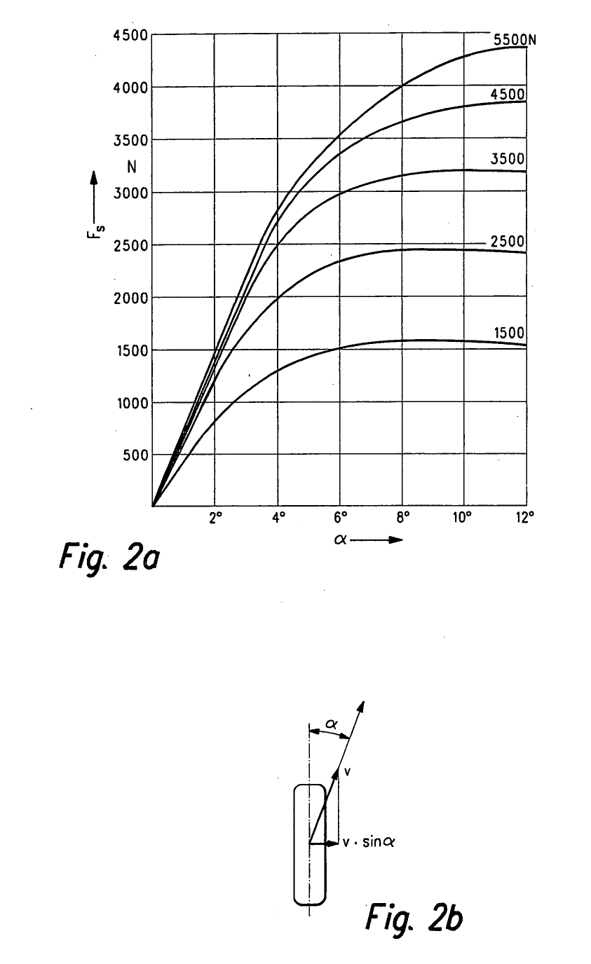

To compensate for the tangential component of the weight force, lateral forces are applied by the tires. Before the lateral forces are explained in greater detail in FIGS. 2a and 2b, the following is pointed out. In the case of a curved highbank, i.e., a banked curve, a centrifugal force, which also has a tangential component, is superimposed on the tangential force component derived from the gravitational force. In this case, the sum of the two tangential components are taken into account.

FIG. 1 shows, at the right, a top view of the vehicle at the right.

At the same time, the need for highbank recognition is apparent from a very simple consideration based on FIG. 1. First, imagine the highbank as not having a curvature, i.e., it is not a banked curve. In the case of an unrecognized highbank, the tangential force induced by the gradient in the road surface may be falsely interpreted as transverse acceleration. Since transverse acceleration enters into the calculations performed by many vehicle operating dynamics control systems, for example, this is not desirable.

FIG. 2a shows the course of the lateral force (ordinate) plotted as a function of the slip angle (abscissa) in a diagram. The various curves in the diagram are based on different vertical tire forces. The information which is to be taken from diagram 2 here is as follows: For a lateral force different from zero, the slip angle must be different from zero.

The concept of the slip angle is explained on the basis of FIG. 2b, which shows a top view of a vehicle wheel. The dash-dot line which points upward represents the plane of the rim. The long arrow, shown as a continuous line, represents the direction of movement of the tire (vector v). The angle between the plane of the rim and the direction of movement of the tire is shown as slip angle α.

A slip angle different from zero means that the vehicle wheel has a velocity component perpendicular to the plane of the rim, shown here as v*sin α. This means that the wheel “slips” or “slides” laterally.

FIG. 3 illustrates the case when the driver would like to compensate for the influence of the highbank on driving performance through steering measures, i.e., putting the front wheels at an inclination. The consideration is again simplest if we consider a road surface without a curvature, i.e., not a banked curve. Let us consider here the inclined front wheels in the top view of the vehicle shown at the right. Imagine the steering measures as being so strong that the “slippage” of the wheels caused by the tangential force is just compensated by the steering measure. The direction of travel desired by the driver is shown by arrow 100. Since a steering angle of the front wheels different from zero and a longitudinal velocity of the vehicle different from zero are both occurring now, a mathematical model implemented in the control unit might then incorrectly deduce that there is a yaw rate different from zero.

Such a model for calculating the yaw rate, known as the single-track model, is presented below. Here again, it would not be desirable for this yaw rate, which has been falsely calculated as being different from zero and which would turn the vehicle in the direction of arrow 101, to be relayed to other vehicle functions. This line of reasoning shall also be summarized again briefly:

Without a steering measure on the part of the driver, the vehicle would slip downward due to the slip angle.

The driver steers against it, then the vehicle drives straight ahead, i.e., the yaw rate is zero.

However, a mathematical model would calculate a yaw rate different from zero, although that would be incorrect.

After these preliminary considerations, which are useful for an understanding, it is now possible to describe example embodiments of the present invention. In one embodiment, as soon as a gradient of a road surface is sensed, the vehicle is at first steered slightly in one direction and then in the other direction. This does not refer primarily to a steering measure initiated by the driver, but instead a driver-independent steering measure, i.e., a steering operation performed automatically by a control unit. This steering operation takes place without any actuation of the steering wheel.

A steering operation or steering measure is understood to refer to the entire following procedure:

Initial steering angle β=0

Starting from β=0, the steering angle is increased up to β=βmax.

Maximum value β=βmax is possibly kept constant for a certain period of time.

Starting from β=βmax, the steering angle is reduced again to β=0.

The initial steering angle is not necessarily required to be β=0. Only the steering angle need be returned to its initial value. Then the steering measure, i.e., steering operation, is concluded.

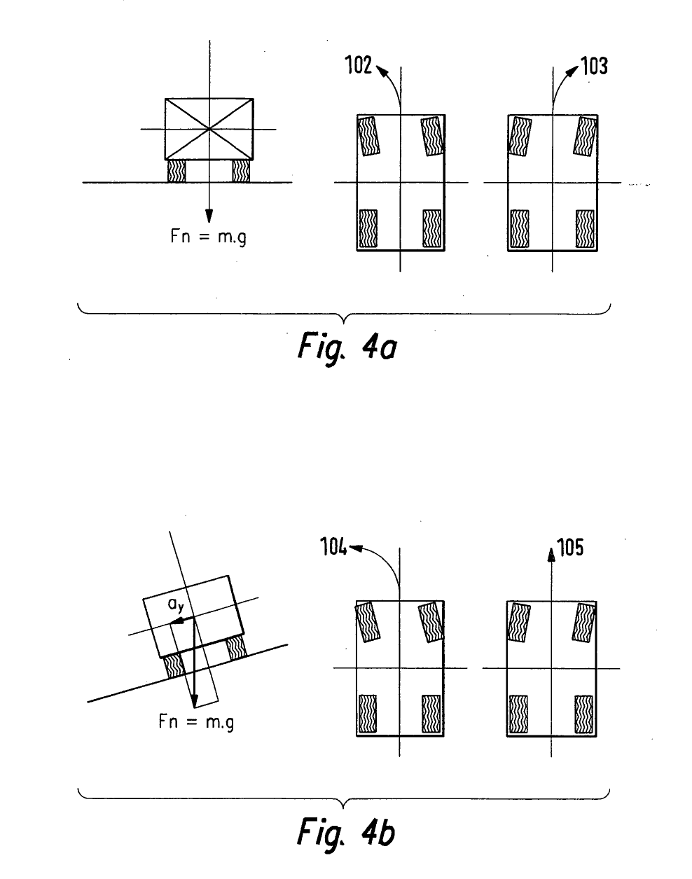

Before discussing FIGS. 4a and 4b, the basics of these two diagrams is explained. Each of these diagrams is composed of three parts from left to right:

Left: rear view of vehicle and road surface

Center: top view of the vehicle, showing the direction of movement when steering to the left (evident from the position of the front wheels)

Right: top view of the vehicle, showing the direction of movement when steering to the right (again evident from the position of the front wheels).

FIG. 4a shows the consequences of these steering measures for driving on a plane. Arrow 102 shows the direction of travel when steering to the left, and arrow 103 shows the direction of travel when steering to the right. In the ideal case, yaw rates equal in value and differing only in sign occur here. In addition, transverse accelerations of the same value but differing in sign also occur here.

FIG. 4b shows the consequences of these steering measures for the case of traveling on a road surface having a transverse gradient. For the sake of simplicity, this shows the special case when steering to the right compensates for “slippage” of the wheels to the left due to the slip angle. Arrow 104 shows the direction of travel with steering to the left, and arrow 105 shows the direction of travel with steering to the right. It can be seen that the two yaw rates belonging to these directions of travel no longer have the same absolute value. When driving straight ahead the yaw rate is zero.

It is thus possible to determine a road surface having a transverse gradient through two steering measures of the same intensity but in different directions. The yaw rate is determined by a yaw rate sensor, for example.

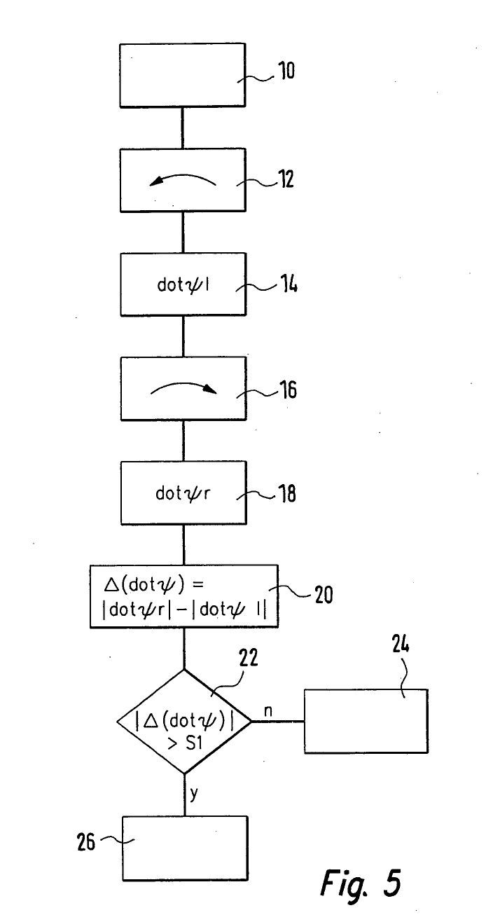

FIG. 5 shows the sequence of determining a road surface gradient across the direction of travel as a flow chart. After the start of the method in block 10, a slight steering movement to the left is initiated and implemented in block 12. During this steering movement, the resulting yaw rate dotψl is measured by a yaw rate sensor in block 14. Then in block 16 a steering movement of the same intensity is initiated and implemented in the opposite direction. During this steering movement, resulting yaw rate dotψr is measured by a yaw rate sensor in block 18. The difference between the amounts is formed in block 20, i.e., Δ(dotψ)=|dotψr|−|dotψr|. Then in block 22 the following query is posed:

|Δ(dotψ)|>S1,

where S1 is a selectable threshold value. If |Δ(dotψ)|>S1, then in block 26 the presence of a highbank is recognized. If |Δ(dotψ)|≦S1, then in block 24, no highbank is recognized. The method sequence shown here may be performed at regular or irregular intervals. It is also possible to use this method only when the presence of a road surface having a transverse gradient is assumed due to other indices.

An index for a curved road surface may exist, for example, if the direction of rotation of the vehicle to be expected on the basis of the measured transverse acceleration and the direction of rotation of the vehicle to be expected on the basis of a yaw rate calculated in a vehicle model have different plus and minus signs.

In another embodiment of the present invention, it is also possible to perform only one steering measure. Here again, this refers primarily to a steering movement initiated by a steering control unit, i.e., not a steering movement implemented by the driver using the steering wheel.

This embodiment presupposes calculation of the yaw rate of the vehicle using a mathematical model. A crossfall of the road surface is then determined on the basis of a comparison of the measured yaw rate with the calculated yaw rate.

To facilitate an understanding, a small insertion regarding an especially simple model for calculation of the yaw rate is appropriate here. The single-track model yields the following equation for this purpose:

$$dot {ψ}^{*} = \frac{1}{( a + c )} \cdot \frac{v}{1 + \frac{{v}^{2}}{{v}_{ch}^{2}}} \cdot δ$$

which is described in technical literature (see for example, “Bosch Automotive Handbook,” 23^{rd} edition, page 707). In addition to longitudinal velocity v of the vehicle and steering angle δ, this equation also includes a characteristic vehicle velocity V_{ch} and distance a of the front wheels from the center of gravity of the vehicle, and distance c of the rear wheels from the center of gravity of the vehicle, dotψ* being the yaw rate calculated with this model. It is also possible to rewrite this equation in the form dotψ*=K(v)*δ where * denotes a multiplication sign. The speed-dependent factor K(v) is obtained directly from the above equation. This factor will also play a role below.

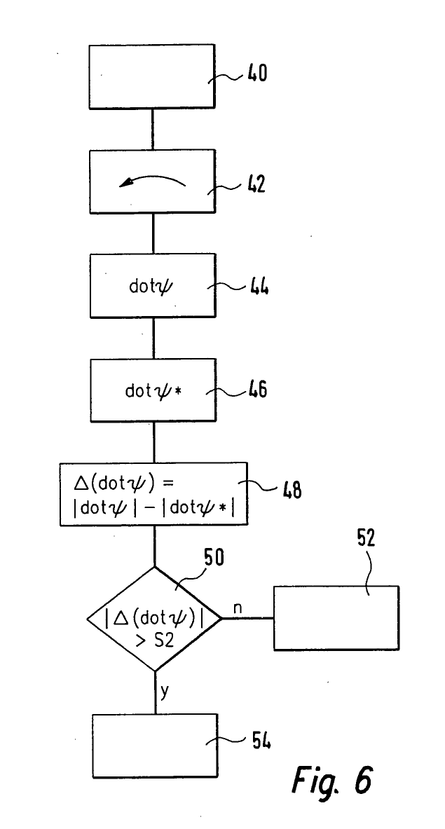

The process sequence in this second embodiment is shown in the flow chart in FIG. 6.

After the start in block 40, a slight steering movement is initiated and implemented in block 42. In block 44 the yaw rate dotψ occurring during this steering movement is measured. This may take place, e.g., by way of a yaw rate sensor. At the same time, yaw rate dotψ* is calculated using a mathematical model in block 46. This may be, for example, the single-track model described above. In block 48, the difference in the amounts Δ(dotψ)=|dotψ|−|dotψ*| is then formed.

Next in block 50 the following query is performed:

|Δ(dotψ)|>S2,

where S2 is a selectable threshold value. If |Δ(dotψ)|>S2, then in block 54 the presence of a highbank is recognized. If |Δ(dotψ)|≦S2, then no highbank is recognized in block 52. The method sequence presented here may be implemented at regular or irregular intervals. It is also possible to use this method only when the presence of a road surface having a transverse gradient is assumed due to other indices.

In this description of the present invention, a road surface is referred to as a highbank above an angle of inclination of approximately 10° to the horizontal. Due to unavoidable interference effects, it is clear immediately that a road surface having a very slight gradient is very difficult to detect using such methods based on steering measures.

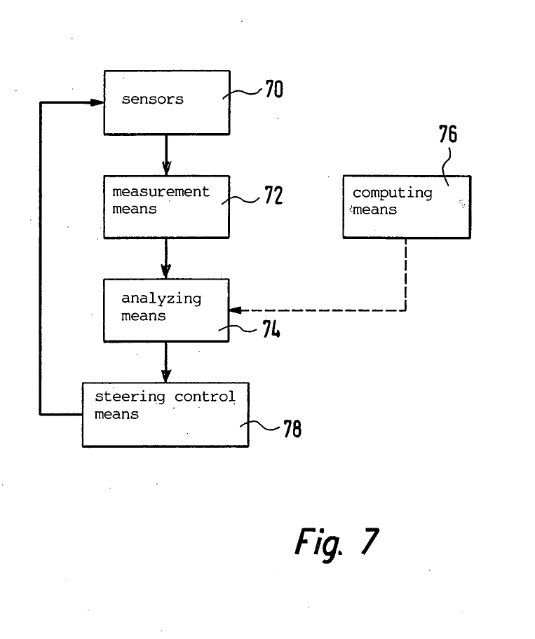

A concluding basic survey of the example embodiment of the present invention is given in FIG. 7. Block 70 contains sensors whose output signals are sent to measurement means 72. In these measurement means, the output signals supplied by sensors 70 are converted to a form suitable for further processing. The output signals of measurement means 72 are sent to analyzing means 74. A decision is made in analyzing means 74 as to whether road surface has a transverse gradient. In addition, it is also possible for the analyzing means to control the method sequence for detection of a road surface having a transverse gradient. In addition to measurement means 72, additional computing means 76 are optionally also present in a special embodiment.

These computing means 76 allow the calculation of variables which influence vehicle operating dynamics by using mathematical models. The output signals of computing means 76 are also sent to analyzing means 74, if computing means are present. The output signals of analyzing means 74 may be used, for example, as input signals for steering control means 78 which initiate the steering operations. During a steering operation, the variables required for highbank recognition are of course detected by sensors 70.

It should also be pointed out that the present invention is especially suitable for vehicles in which the traditional steering has been replaced and/or supplemented by a final control element. This final control element is able to permit an active adjustment of steering measures without the assistance of the driver. The term “steer-by-wire” and the superimposed steering mentioned above should be included as examples here.

In addition, it should also be pointed out that in the exemplary embodiments, the yaw rates calculated and/or measured by a yaw rate sensor have been used as variables for determination of a highbank. It should be emphasized that the transverse acceleration may also be used instead of the yaw rate, for example. This then presupposed a transverse acceleration sensor instead of or in addition to the yaw rate sensor.

The following general relationship is assumed for transverse acceleration ay:

ay=f(m,g,η,v,dotψ),

where m is the vehicle mass, g is acceleration due to gravity (approx. 9.81 m/s\hat{ }2), v is the velocity of the vehicle, dotψ is the yaw rate, and η is the angle of inclination of the highbank to the horizontal.

This equation may be linearized approximately as follows:

ay=(m*g*η)+(v*dotψ),

where * is the multiplication sign. In this equation, the first addend takes into account the influence of the highbank (=tangential component of the force due to weight) and the second addend takes into account the influence of centrifugal force.

The single-track model yields

dotψ=K(v)*δ,

where δ is the steering angle. Thus,

ay=(m*g*η)+(v*K(v)*δ).

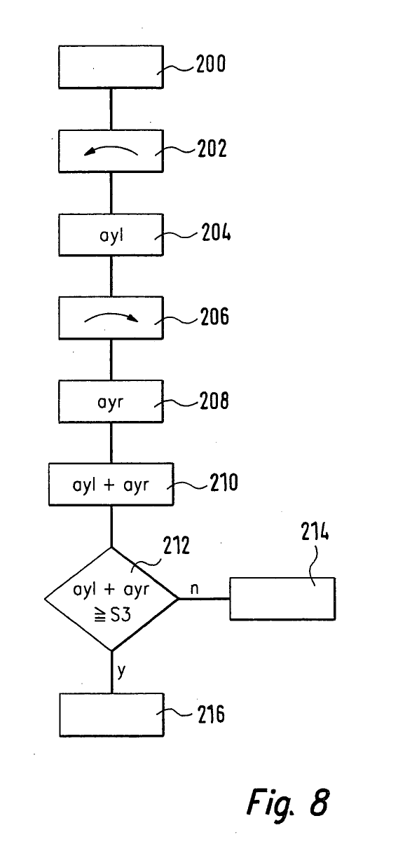

Therefore, the two methods described here may now also be represented as based on transverse acceleration. The method illustrated in FIG. 8 corresponds to the method illustrated in FIG. 5. One difference is that it uses transverse acceleration instead of yaw rate. This method takes place as follows after the start in block 200:

Steering movement to the left with steering angle +δ (block 202), measurement of resulting transverse acceleration ayl (block 204).

Steering movement to the right with steering angle −δ (block 206), measurement of resulting transverse acceleration ayr (block 208).

The sum of the transverse accelerations is formed in block 210: ayl+ayr=2*(m*g*η).

This means that we measure the transverse acceleration with a steering movement to the left and a subsequent steering movement to the right. If the sum of the two terms exceeds a predefinable limit value, then the vehicle is on a highbank. The query as to whether this limit value S3 is exceeded is asked in block 212. If it is not exceeded, then in block 214 it is recognized that there is no highbank inclined transversely to the direction of travel. If the limit value is exceeded, then in block 216 a highbank inclined transversely to the direction of travel is recognized.

It is even possible to thus calculate the angle of inclination of the highbank to the horizontal:

η=(ayl+ayr)/(2*m*g).

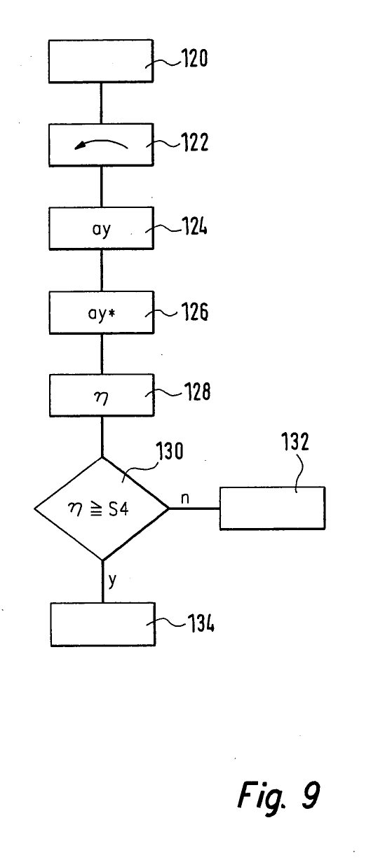

The method illustrated in FIG. 9 corresponds to the method illustrated in FIG. 6. One difference is that it uses transverse acceleration instead of yaw rate. The method illustrated in FIG. 9 takes place as follows after the start in block 120:

Steering movement with steering angle δ (block 122).

Measurement of the resulting transverse acceleration ay (block 124). The following equation holds by approximation for measured transverse acceleration ay:

ay=(m*g*η)+(v*K(v)*δ) with a steering angle δ.

Calculation of ay*=v*K(v)*δ using a mathematical model in block 126.

Calculation of η by using η=(ay−ay*)/(m*g) in block 128. If the value of η exceeds a predefinable limit value S4, a highbank is recognized.

The query as to whether this limit value S4 is exceeded is asked in block 130. If it is not exceeded, then a highbank inclined transversely to the direction of travel is not recognized in block 132. If the limit value is exceeded, then the presence of a highbank inclined transversely to the direction of travel is recognized in block 134.

The method sequences presented here may be performed at regular or irregular intervals. It is also possible to use these methods only when the presence of a road surface having a transverse gradient is assumed due to other indices.

In addition, it should also be emphasized that the example method according to the present invention is also suitable for detection of a banked curve. A highbank without a curvature has frequently been used as the basis for consideration in the description in order to provide greater clarity.

What is claimed is:

1. A device for recognizing a road surface gradient across the direction of travel, usable in a vehicle equipped with
measurement means (72) for detecting at least one variable describing the operating dynamics of the vehicle, and
analyzing means (74) for recognizing the crossfall of a road surface,
wherein the vehicle has steering control means (78), and for recognition of the crossfall of the road surface
at least one steering operation performed independently of the driver is initiated by the steering control means (78) on wheels designed to be steerable, and
at least one variable which influences the operating dynamics of the vehicle is detected in the measurement means (72) during the steering operation, and
a crossfall of the road surface is recognized in the analyzing means (74) at least by analyzing the variable which influences the operating dynamics of the vehicle during the at least one steering operation.

2. The device as recited in claim 1, wherein the yaw rate (dotψr, dotψl, dotψ) and/or the transverse acceleration (aq, aql, aqr) is detected in the measurement means (72) during the at least one steering operation.

3. The device as recited in claim 1, wherein two steering operations performed independently of the driver in opposite directions are initiated by the steering control means (78) on wheels designed to be steerable.

4. The device as recited in claim 3, wherein the yaw rate (dotψr, dotψl) and/or the transverse acceleration (aqr, aql) of the vehicle is determined in the measurement means (72) during both steering operations.

5. The device as recited in claim 4, wherein detection of a road surface gradient across the direction of travel is based on a comparison performed in the analyzing means (74), the two yaw rates (dotψr, dotψl) and/or the transverse accelerations (aqr, aql) determined during the two steering operations entering into the comparison.

6. The device as recited in claim 1, wherein
a steering operation performed independently of the driver is initiated in the steering control means (78) on wheels designed to be steerable,
a variable which describes the operating dynamics is determined by the measurement means (72) during the steering operation,
the vehicle has computing means (76) for determining at least one variable which describes the operating dynamics of the vehicle with the help of a model,
a variable (dotψ*, aq*) which describes the operating dynamics of the vehicle is calculated in the computing means (76), and
for detection of a road surface having a transverse gradient in the analyzing means (74), the variable (dotψ, aq) determined in the measurement means (72) and the variable (dotψ*, aq*) calculated in the computing means (76) are used.

7. The device as recited in claim 6, wherein
the yaw rate (dotψ) and/or the transverse acceleration (ay) of the vehicle is determined by the measurement means (72) during the one steering operation,
the yaw rate (dotψ*) and/or the transverse acceleration (ay*) of the vehicle is calculated in the computing means (76), and
the detection of a road surface gradient across the direction of travel is based on a comparison performed in the analyzing means (74), the comparison being based on
the yaw rate (dotψ) determined as well as the calculated yaw rate (dotψ*) and/or
the transverse acceleration (aq) determined as well as the calculated transverse acceleration (aq*).

8. The device as recited in claim 7, wherein the yaw rate (dotψ*) is calculated in the computing means (76) by a model using the longitudinal velocity (v) of the vehicle and the steering angle (δ) of the front wheels as input variables, and/or the transverse acceleration is calculated by a model using the longitudinal velocity (v) of the vehicle as an input variable.

9. A method for recognizing a road surface gradient across the direction of travel, usable in a vehicle equipped with
measurement means (72) for detecting at least one variable describing the operating dynamics of the vehicle, and
analyzing means (74) for recognizing the crossfall of a road surface,
wherein the vehicle has steering control means (78) and the following steps:
initiation of at least one steering operation, not performed by the driver, by the steering control means (78), and
detection of at least one variable which influences the operating dynamics of the vehicle through measurement means (72) during the steering operation, and
recognition of a transverse gradient of a road surface at least by analyzing the variable which influences the operating dynamics of the vehicle in the analyzing means (74) during the at least one steering operation.

10. The method as recited in claim 9, wherein the yaw rate (dotψr, dotψl, dotψ) and/or the transverse acceleration (aq, aqr, agl is detected in the measurement means during the at least one steering operation.
